(19) United States
(12) Patent Application Publication
(10) Pub. No.: US 2023/0355459 A1
(43) Pub. Date: Nov. 9, 2023

(54) WALKER

(71) Applicant: The Helping Hand Company (Ledbury) Limited, Herefordshire (GB)

(72) Inventors: Stuart Moore, Herefordshire (GB); Gavin James, Herefordshire (GB)

(21) Appl. No.: 18/195,020

(22) Filed: May 9, 2023

(30) Foreign Application Priority Data
May 9, 2022 (GB) 2206720.1

(51) Int. Cl. A61H 3/04

(52) U.S. Cl. CPC A61H 3/04

(57) ABSTRACT

A walker is provided for assisting a person to walk independently, the walker including a frame, one or more wheels connected to a base of the frame, a seat connected to the frame, in which the seat is configurable into a lowered and raised position and/or in which the seat can swivel and a resistance means is provided for resisting rotation of the seat about its pivot during use.

### CROSS REFERENCE TO RELATED APPLICATIONS

This application claims the benefit of priority to Great Britain application No. GB 2206720.1, filed on May 9, 2022; the entirety of which is hereby incorporated by reference herein.

### BACKGROUND OF THE INVENTION

### Field of the Invention

The present invention relates to a walker for assisting a person to walk independently.

### Background

An adult or child may have difficulty in walking independently as a result of a mental and/or physical disability, which may result from a disease and/or deterioration due to age. If a person has had an accident which resulted in a disability, then they can have difficulty learning to walk independently again.

In instances where a person cannot walk independently, they typically require help from other people such as a parent, legal guardian, a friend or another carer to assist them to stand up and in providing continuous support when standing or whilst walking, if they are unable to support their own weight and/or control their movement.

Various different walkers or walking aids are available for aiding people to walk (or learn to walk) independently or with a degree of independence. A walker can allow a person to walk without needing continuous physical support from another person, enabling the person to have a greater degree of autonomy, although it can be difficult to learn to walk ergonomically in a walker.

A conventional walker has a frame with wheels at each corner and a support seat in the middle. The seat is useful in case the person using the walker becomes tired and needs to rest. However, the seat can get in the way of their legs when they are walking, which makes it more difficult to use the walker. This is particularly undesirable because the person who is using the walker already has difficulty walking without the seat getting in the way, making it even harder to learn to walk ergonomically.

In some cases, a person may use a wheelchair at some times but rely on a walker at other times. However, a walker is not typically designed in a way that facilitates a transition from a wheelchair to the walker (or vice versa), so it can require time and care to transit safely between the two.

It is an object of the present invention to reduce or substantially obviate the aforementioned problems.

### SUMMARY OF THE INVENTION

According to a first aspect of the present invention, there is provided a walker (or walking apparatus/mobility aid) for assisting or enabling a person to walk more independently, the walker comprising:
a frame including a first frame portion and a second frame portion, the second frame portion being movable relative to the first frame portion via at least one pivotal connection;
one or more wheels connected to the first frame portion for rolling the walker along the ground;
a seat connected to the second frame portion and disposed rearwardly of the at least one pivotal connection, the seat and the second frame portion being configurable into a lowered position for a person to enter or exit the walker, and into a raised position for the person to walk using the walker; and
seat positioning means configured or arranged for use in moving the second frame portion relative to the first frame portion for moving the seat between the lowered and raised positions.

Advantageously, this allows a person (especially a disabled person or child) wishing to use the walker to easily enter the walker since it is configurable to move into an accessible lowered position. This means that, for example, a person on a wheelchair does not have to be fully in a standing position to reach the seat and allow their body to be positioned on the walker. The person using the walker can therefore mount the walker more easily and quickly, if needed with the assistance of their parent or carer. Moving the seat and associated frame into the raised position assists in moving the user into the optimum position for stability when standing and walking using the device.

A given pivotal connection may be considered to include multiple (possibly spaced apart) coaxial pivotal connections.

The term “rearwardly” is used in relation to the pivotal connection to mean that the seat is nearer to an imaginary vertical plane disposed at a rear of the walker than the pivotal connection. The majority of the walker is disposed in front of a person in the walker during use, hence the person is closer to the rear of the walker than they are to the front of the walker.

The second frame portion may be considered to include the seat positioning means. The seat positioning means may be pivotally connected to the first frame portion. The seat positioning means may be pivotally connected to a rear section of the first frame portion.

A front end of the frame may be disposed ahead of the at least one pivotal connection.

The first frame portion may extend from the front end to a rear end of the walker.

The at least one pivotal connection may be disposed in a middle region of the first frame portion between the front end and rear end of the walker.

The seat may be disposed above the first frame portion.

In the raised position, the seat may be disposed above a horizontal plane at the at least one pivotal connection. That is, for an imaginary plane disposed horizontally (relative to the ground) at the level or height of the pivotal connection at the first frame portion, the seat may be disposed above the plane.

In the lowered position, the seat may be disposed above the horizontal plane at the at least one pivotal connection.

The horizontal plane may be substantially parallel to a plane of the first frame portion.

The second frame portion may be disposed above the first frame portion.

The second frame portion may be pivotally mounted to the first frame portion. This allows the second frame portion and the seat to be moved between the lowered and raised positions (or vice versa) while the first frame portion stays in contact with the ground.

The seat positioning means may include or be a third frame portion. The third frame portion may be pivotally connected to the first frame portion at a first pivotal connection (which may comprise left and right connections to either side of a central median (or sagittal) plane). The third frame portion may be pivotally connected to the second frame portion at a second pivotal connection (which may comprise left and right connections to either side of a central median (or sagittal) plane). The first and second pivotal connections may be provided on parallel but offset axes.

The seat may be disposed rearwardly of the first pivotal connection. The seat may be disposed substantially in the region above the second pivotal connection.

Providing a third frame portion (or part of the second frame portion) for the seat positioning means provides a robust and easy-to-operate mechanism. The seat positioning means may be considered to be a seat positioning mechanism or switch.

The seat positioning means may include a handle or lever disposed at and/or operable from a front end of the walker. The handle or lever may be part of the frame. A major portion or length of the seat positioning means may be provided forward of the pivotal connection to the first frame portion, with a minor portion or length to the rear of that pivotal connection.

This provides an easily accessible and simple-to-use mechanism for raising and lowering the seat. Providing the handle/lever at the front also means that the carer or other person actuating the handle/lever can see the person in the walker as the seat is raised in case raising the seat destabilises them and intervention is needed.

Actuation of the handle/lever between the two positions may cause pivoting through an angle exceeding 45 degrees, optionally exceeding 60 degrees, and optionally in the region of about 90 degrees. The pivoting may be about the first pivotal connection.

The seat positioning means may be configured or arranged to move the seat (a) both upwards and forwards from the lowered position, and/or (b) both downwards and rearwards from the raised position.

This allows the seat to be positioned optimally in one step as opposed to discrete movement in each direction (up/down and forward/backward).

The raised position may be an uppermost position of the seat. That is, the seat may not be raised further than the raised position.

The lowered position may be a lowermost position of the seat. That is, the seat may not be lowered further than the lowered position.

The seat may be secured either in the raised position or the lowered position, but not at an intermediate position between the raised and lowered positions. That is, the mechanism for moving the seat may be limited to stably providing the seat in only the raised and lowered positions, which may be at the extreme limits or ends of the range of seat movement.

In the lowered position, the seat may be disposed above the horizontal plane at the at least one pivotal connection.

The seat may be oriented at a first tilt angle (such as horizontal) in the raised position. The seat may be oriented at a different second tilt angle in the lowered position. That is, by moving the seat from the raised position to the lowered position (or vice versa), the tilt angle of the seat may change. For example, the seat may be substantially horizontal or level in the raised position, and may be tilted in the lowered position such as tilted rearwardly (with the front of the seat higher than the rear of the seat).

Lift means (or other assistance means) may be connected to the seat positioning means for assisting controlled movement of the second frame portion and the seat between the raised and lowered positions.

This allows the movement of the seat positioning means to be controlled more easily, particularly when lowering the seat.

The lift means may be connected to the seat positioning means. The lift means may be connected to the frame, such as the first frame portion. The lift means may be connected between the seat positioning means and the first frame portion.

This can limit the displacement of the seat positioning means (particularly as a handle/lever) away from the first frame portion, so that the seat does not drop too low and/or the second frame portion does not move too far, in case it destabilises the person before they can exit the walker.

The lift means may include a piston or gas strut.

Locking means may be provided for releasably securing the second frame portion and the seat in one of the lowered and raised positions.

This improves safety for the user by preventing the second frame portion and the seat from accidentally moving into the lowered position while the walker is in use, for example. It also prevents the second frame portion and the seat moving from the lowered position as the person using the walker enters and exits the walker.

The first frame portion may include a U-shaped member or portion. The U-shaped part may be arranged laterally. The closed end of the U-shaped part may be at the front of the walker for providing space to step forward within the frame.

The seat positioning means may include a corresponding U-shaped member or portion for substantially overlying the first frame portion when the seat and second frame portion are in the raised position.

This means that the handle/lever (or other seat positioning means) does not reduce or block the space provided for the user to step forwards within the walker. The elongate nature of the U-shaped seat positioning handle/lever also minimises the force required to move the handle/lever between the two positions corresponding to the raised and lowered seat positions.

The first frame portion may include two approximately Y-shaped members or portions. The Y-shapes may be asymmetric such that each of the three arms is a different length.

Each Y-shaped part may be disposed towards a rear end of the walker for accommodating rear wheels. Each Y-shaped member may be connected to a respective side of the open end of the U-shaped member. The at least one pivotal connection may be provided at an upper end of each Y-shaped member.

The Y-shaped members provide a connection to the U-shaped member of the first frame portion on one arm, for a wheel at another arm, and for the pivotal connection to the seat positioning means on the remaining arm.

The wheel-accommodating arm of the Y-shaped part may curve (optionally through about 90 degrees) into the upright arm which has the pivotal connection. The other arm which connects to or transitions into the rest of the first frame portion may be arranged at a 90 degree offset from the upright arm for extending towards the front end of the walker.

The Y-shaped members may each be provided in a substantially vertical plane.

Each Y-shaped member may comprise two Y-shaped plates for sitting to either side of a wheel. A space between the Y-shaped plates may also accommodate guide sleeves for legs of the second frame portion (see below).

In terms of frame structure, the second frame portion may comprise a first, second and third section.

The first section of the second frame portion may include an L-shaped member or portion such as a bracket. The seat may be mounted to a distal end of the L-shaped part. The L-shaped part may be disposed substantially centrally between left and right sides of the walker. The height of the L-shaped part relative to the second frame portion may be adjustable for adjusting the seat height in the raised position.

The L-shaped part allows the seat to be supported in a position towards the rear of the walker, spaced from the second frame portion.

The second section may be attached or joined to the first section. The second frame portion may include a cross bar across a second end of the L-shaped member or portion. First and second arms (or legs) may extend downwards from the cross bar on either side of the seat. The first and second arms may be inverted L-shaped when viewed from the side of the walker.

The cross bar may extend from a left/right side of the L-shaped member towards a left/right side of the frame, and the respective arm/leg may then extend towards the rear end of the frame and subsequently towards the base of the frame, terminating at a second end. The parts of each arm extending towards the base of the frame may be parallel to each other.

The third section may be moveably/slidably connected to the second section. The third section may comprise guide members for guiding the movement/sliding of the first and second arms of the second section respectively.

The frame may include first and second guide members arranged to receive at least part of the second frame portion (preferably lower ends of the first and second arms) therethrough for guiding movement of the second frame portion when the seat and second frame portion are raised or lowered.

The guide members and first and second arms cooperate to control the manner in which the second frame portion moves when the seat is raised or lowered. The guide members also resist skewing of the second frame portion relative to the first frame portion, which could damage the pivotal connection.

Bottom ends of the first and second arms may touch the ground when the seat is in the lowered position, for resisting rolling of the walker. Alternatively, the bottom ends of the arms may not touch the ground in the lowered position. A brake may be provided on the one or more wheels.

In the lowered position, the lower end of each arm may extend through the first end of a guide member. In the raised position, the lower end of each arm may be disposed within the respective guide member.

The first and second guide members of the second frame portion may each be pivotally mounted to the first frame portion (preferably the Y-shaped parts). This allows the guide sleeves to tilt forwards or rearwards as the second frame portion and seat are raised or lowered respectively.

The guide members may be substantially vertical when the seat is in the raised position. The guide members may be off-vertical when the seat is in the lowered position.

The guide members may extend in a direction parallel to the arm of the L-shaped member which does not carry the seat.

The seat positioning means may actuate movement of the second frame portion. More particularly, the seat positioning means may actuate movement of the first and second arms of the second frame portion through or relative to the guide members.

Ends of the seat positioning means may be pivotally connected (by the second pivotal connections) to each arm of the second section of the second frame section, optionally by brackets on the arms.

The seat may be rotatably connected to the frame at a pivot for rotating in either direction about a substantially vertical axis. Resistance means may be provided and configured to provide a force for resisting rotation of the seat in either direction about the pivot. Control means may be provided for adjusting the force provided by the resistance means. The advantages are similar to those discussed in the second aspect of the invention below.

According to a second aspect of the invention, there is provided a walker for assisting a person to walk independently, the walker comprising:
a frame;
one or more wheels at the base of the frame for rolling the walker along the ground;
a seat rotatably connected to the frame at a pivot for rotating about a substantially vertical axis in either direction; and
resistance means or a tension adjuster configured to provide a force for resisting rotation of the seat in either direction about the pivot.

Advantageously, the rotatable seat and resistance means that limits the seat rotation allows a person to (learn to) walk with a more natural walking gait, and provides a more comfortable experience for the user while learning how to walk (or simply walking) using the walker.

Control means such as a knob or dial may be provided for adjusting the force provided by the resistance means. This allows the degree of resistance provided by the resistance means to be adjusted according to the required resistance for the specific needs, walking gait and disabilities of the person using the walker. In other words, it allows the swivelability of the seat to be customised for a particular user.

The resistance means may be connected to the seat directly or indirectly.

The seat or resistance means may include a leaf spring. Adjusting the tension of the leaf spring can customise the force resisting seat swivel.

The resistance means may comprise a cable or other elongate member (such as a ribbon). The elongate member may be connected at one end to the seat (preferably part a lower portion of the seat proximal to or at the pivot axis. The elongate member may be connected at another end to another part of the walker or frame. The ribbon or cable may be made of an elastically deformable material, such as a metal or plastic.

The resistance means may comprise a block, which may be moveable or slidable relative to the pivot axis of the seat. The block may have a groove or channel for receiving the elongate member.

The lower end of the seat (or a seat column) may be provided for mounting to or sitting through part of the frame. The lower end may include a groove or channel to which the elongate member is secured or attached.

Swivelling the seat during use imparts a force which deforms the elongate member out of shape, which correspondingly provides some degree of resistance to seat swivel. As the seat swivels further from the default forward-facing position, the level of resistance can increase as the elongate member is deformed to a larger extent.

The proximity of the block to the pivot axis affects the rate at which resistance increases with seat swivel angle to either side of the forward-facing position.

The resistance means may be provided within an enclosed housing (such as the L-shaped member discussed with respect to the first aspect of the invention). Left and right sidewalls of the housing may prevent excessive deformation of the elongate member as the seat swivels. That is, the housing walls may provide a substantial limit or restriction to rotation of the seat clockwise or anticlockwise, limiting the overall angular range of seat swivel.

The block may be disposed within a channel in the enclosed housing. The width of the block may substantially match an internal width of the housing.

The block can be slid within the enclosed housing by the control means. When the block is close to the pivot axis, comparatively high resistance to seat swivel is provided. When the block is further from the pivot axis, comparatively lower resistance to seat swivel is provided.

According to a further aspect of the invention, there is provided a walker (or walking apparatus/mobility aid) for assisting or enabling a person to walk more independently, the walker comprising:
a frame including a first frame portion and a second frame portion, the second frame portion being movable relative to the first frame portion via at least one pivotal connection;
one or more wheels connected to the first frame portion for rolling the walker along the ground;
a seat connected to the second frame portion and disposed rearwardly of the at least one pivotal connection, the seat and the second frame portion being configurable into a lowered position for a person to enter or exit the walker, and into a raised position for the person to walk using the walker; and
seat positioning means configured or arranged for use in moving the second frame portion relative to the first frame portion for moving the seat between the lowered and raised positions.

The advantages are similar to the first aspect of the invention. Any feature or combination of features presented with respect to the first aspect of the invention may be independently selected for inclusion in this aspect of the invention.

According to a further aspect of the present invention, there is provided a frame assembly for a walker for assisting a person to walk more independently, the frame assembly comprising:
a first frame portion and a second frame portion, the second frame portion being movable relative to the first frame portion via at least one pivotal connection;
a seat or seat mount connected to or on the second frame portion and disposed rearwardly of the at least one pivotal connection, the seat and the second frame portion being configurable into a lowered position and into a raised position; and
seat positioning means configured or arranged for use in moving the second frame portion relative to the first frame portion for moving the seat between the lowered and raised positions.

The advantages are similar to the first aspect of the invention.

According to a further aspect of the present invention, there is provided a seat assembly for a walker for assisting a person to walk more independently, the seat or seat assembly comprising:
a frame portion or seat mount for connection to a walker frame;
a seat rotatably connected to the frame portion or seat mount at a pivot for rotating about a substantially vertical axis in either direction;
resistance means configurable to provide a force for resisting rotation of the seat in either direction about the pivot; and
control means for adjusting the force provided by the resistance means.

The advantages are similar to the second aspect of the invention.

It will be appreciated that any feature or combination of features presented with respect to one aspect of the invention may be provided in the other aspect of the invention.

Furthermore, any of the following features may be provided in any of the aspects of the invention.

The seat may be tiltable about a lateral axis relative to the frame. Tilt adjustment means may be provided for setting a forward and/or rearward tilt angle of the seat.

This further enables the seat to follow the movement of the hips and the legs of the person using the walker and thus facilitates development of a more natural walking gait by the user.

The frame may include a body support member for positioning around the person's torso or waist to support them against falling over. The substantially vertical axis about which the seat pivots may pass through a central region of a space defined by the body support member.

The body support member may be adjustably connected to the frame, or otherwise movable openable to facilitate entry into and exit from the walker.

The body support member may include an open position and a closed position. The open position allows the person to enter the walker. The closed position allows the body support member to support the body of the person using the walker.

The body support member may be disposed at the rear end of the frame.

The seat may be disposed between the body support member and the rear wheels.

The seat may be disposed at or towards the rear end of the frame.

The frame, particularly the second frame portion, may include a front grip portion for the person to grip for stability during use. This may be in the form of a loop or ring, for example.

A seat back may be provided at a rear of the seat. The seat back may be pivotally attached to the seat for dropping the back below the level of the seat for ease of sitting on the seat when entering the walker, and for ease of standing up from the seat when exiting the walker.

One or more shock absorbers may be provided on the frame. This reduces or mitigates the effects of impacts and bumps when rolling the walker along the ground during use.

A sleeve may be provided around each shock absorber to protect the shock absorbers from damage, and to avoid personal injury to the user if their clothing was to catch in the shock absorber during walker use, for example.

The seat may be considered to be a saddle. The shape of the saddle allows the person using the walker to comfortably rest their body on the saddle to be held and supported in a standing or walking position. The saddle also allows the person to walk with substantially natural walking gait since their legs and hips are not restricted to move by the saddle.

The first frame portion may be disposed at the base of the frame. This facilitates facile connection to the one or more wheels for rolling the walker along the ground.

Front wheels and rear wheels may be connected to the first frame portion.

Two front wheels may be provided. Each front wheel may be disposed on either side of the front end of the frame, optionally towards the closed end of the U-shaped part. Each front wheel may be a castor wheel or similar which allows free rotation of the wheel. This allows the person using the walker to easily direct the walker in any direction desired.

Two rear wheels may be provided. Each rear wheel may be disposed on each side of the rear end of the frame, optionally housed or accommodated in the Y-shaped parts. Each rear wheel may be a fixed wheel. This provides some control over the movement of the walker along the ground.

The second frame portion and the seat may be disposed at or towards the rear end of the frame. This allows the person using the walker to enter from the rear of the walker, and face towards the direction of the seat (and direction of subsequent walker use) when entering the walker. In addition, this allows the person using the walker to exit the walker from a position which enables them to be sit down in a wheelchair, for example, without having to turn around.

The seat may be disposed between the rear wheels. In other words, the seat may be disposed substantially on a central axis of the walker extending from the front end to the rear end of the walker. This allows the person's weight to be supported centrally between the rear wheels thereby allowing for an even loading of the walker for better stability.

### BRIEF DESCRIPTION OF SEVERAL VIEWS OF THE DRAWINGS

For a better understanding of the present invention, and to show more clearly how it may be carried into effect, reference will now be made by way of example only to the accompanying drawings, in which:

FIG. 1 shows a perspective view of a frame of a walker with its seat in a lowered position;

FIG. 2 shows a side view of the walker of FIG. 1;

FIG. 3 shows a perspective view of the walker of FIG. 1 with its seat in a raised position;

FIG. 4 shows a side view of the walker of FIG. 3;

FIG. 5A shows an underside partial perspective view of part of the seat and frame of the walker of FIG. 1, showing a resistance means in a first position;

FIG. 5B shows an underside partial perspective view of the region depicted in FIG. 5A, showing internal parts;

FIG. 6A shows another underside partial perspective view of the region depicted in FIG. 5A, showing the resistance means in a second position;

FIG. 6B shows an underside partial perspective view of the region depicted in FIG. 6A, showing internal parts;

FIG. 7A shows a further underside partial perspective view of the region depicted in FIG. 5A, showing the resistance means in a third position;

FIG. 7B shows an underside partial perspective view of the region depicted in FIG. 7A, showing internal parts;

FIG. 8 shows an enlarged partial perspective view of a lift means of the walker of FIG. 1; and

FIG. 9 shows an enlarged partial perspective view of the lift means of the walker of FIG. 3.

### DETAILED DESCRIPTION OF THE ILLUSTRATED EMBODIMENTS

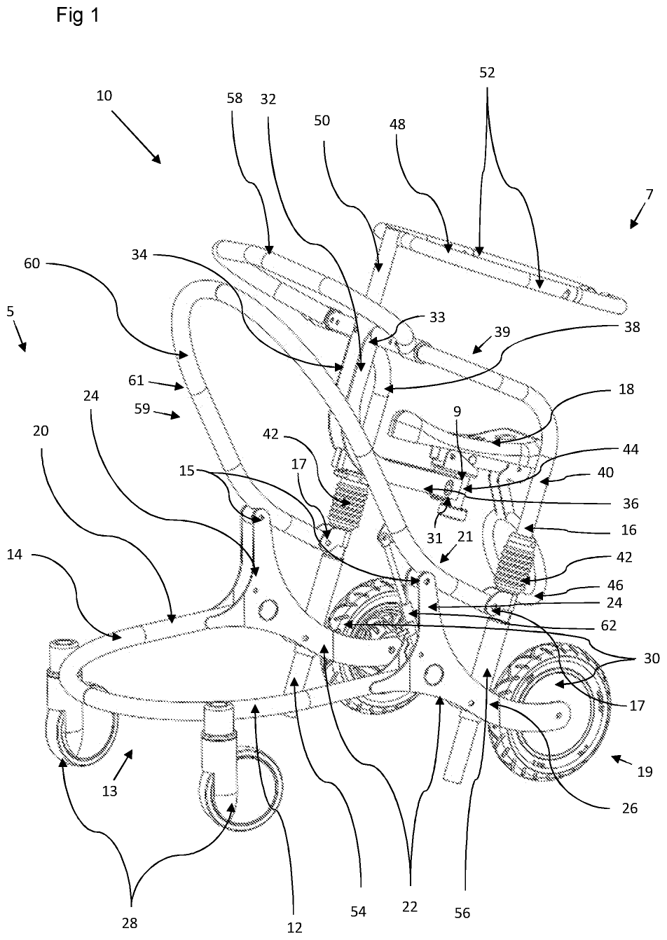

Referring firstly to FIGS. 1 to 4, a walker for use by a person to aid themselves to walk is indicated generally at 10. A front end 5 of the walker 10 is at the left side of FIG. 1 and a rear end 7 of the walker 10 is at the right side of FIG. 1 as shown.

The walker 10 comprises a frame 12 which has a front end 13, a rear end 19 and a base. The frame 12 includes a first frame portion 14 and a second frame portion 16. A seat positioning means 60 includes a third frame portion 59 and is pivotally connected at pivotal connection 15 to the first frame portion 14. The second frame portion 16 is pivotally connected 17 to another part of the seat positioning means 60. A seat (or saddle) 18 connected to the second frame portion 16.

The first frame portion 14 is disposed at the base of the frame 12 and may be considered as a base frame. The first frame portion 14 includes a U-shaped member 20 arranged laterally, with the closed end of the U-shaped member at the front of the walker 10. The U-shaped member has a U-shaped profile when viewed from above. The U-shaped member 20 defines a stepping space within the walker 10.

There are also two approximately Y-shaped members 22 disposed at the rear end of the frame 12. Each Y-shaped member has a Y-shaped profile when viewed from the left or right side of the walker 10. The Y-shaped members 22 are connected to either side of the open end of the U-shaped member. The Y-shaped members 22 are each disposed in a vertical plane. Each Y-shaped member includes two Y-shaped plates spaced apart from each other for accommodating a wheel and frame guide member.

The pivotal connection 15 is provided at an upper end 21 of each Y-shaped member 22.

Each Y-shaped member 22 of the first frame portion 14 comprises an approximately V-shaped body 24 having two ends and an elongate body 26. A first end of the elongate body 26 extends substantially centrally from a convex side of the V-shaped body 24.

A first end of the V-shaped body 24 of each Y-shaped member 22 is connected to an end of the U-shaped member 20, forming the first frame portion 14.

Two front wheels 28 are connected at either side of the U-shaped member 20. The front wheels 28 connect to respective wheel housings which are spaced apart on the U-shaped member 20 at the front end of the walker 10. The wheels 28 are disposed to either side of a centre of the U-shaped member 20. Two rear wheels 30 are also provided. Each rear wheel 30 is connected to a second end of the elongate body 26 of each Y-shaped member 22 at the rear end of the frame 12. The wheels 28, 30 allow the walker 10 to be easily rolled along the ground during use.

The second frame portion 16 comprises an L-shaped member 32. The L-shaped member 32 has first and second flanges 34, 36 extending perpendicularly to each other. First and second arms 38, 40 extend laterally from the L-shaped member 32 as a cross bar 39, then rearwardly and finally downwardly towards the first frame portion 14 on either side of the seat 18. First and second guide members 54, 56 are provided for guiding the sliding movement of the first and second arms 38, 40 respectively.

A first end of each arm 38, 40 is connected to a side of the L-shaped member 32. Each arm 38, 40 extends in opposing directions from a side of the first flange of the L-shaped member 34 towards a side of the frame 12. Each arm 38, 40 then extends substantially parallel to the other arm towards the rear end of the frame 12. Each arm 38, 40 then extends substantially parallel to the other arm towards the base of the frame 12, terminating at a second end. The parts of each arm 38, 40 extending towards the ground are parallel to each other.

The first flange 34 of the L-shaped member 32 is substantially parallel to the part of the first and second arms 38, 40 extending towards the base of the frame 12. The second flange 36 is substantially perpendicular to the part of the first and second arms 38, 40 extending towards the base of the frame 12.

The seat 18 is rotatably connected to the frame 12 about a pivot 9 for rotating in either direction.

A seat rod or mount 44 is provided on the underside or lower end of the seat 18 for connecting the seat 18 to the frame 12. The seat rod 44 is connected to a distal end 31 of the second flange 36 of the L-shaped member 32. In other words, the seat rod 44 is connected to an end 31 of the second flange 36 opposite the connection of the second flange 36 with the first flange 34.

The second flange 36 of the L-shaped member 32 and the major length of the seat 18 extends in a direction between the front end and the rear end of the frame 12. The first flange 34 of the L-shaped member 32 extends upwards away from the first frame portion 14.

A back support member (or seat back/back rest) 46 is provided on the seat 18. The back support member 46 is pivotally attached to a rear end of the seat 18 for dropping it to a position below the seat. The back support member 46 allows the upper body of the person using the walker 10 to be supported and prevents the person falling backwards off the seat 18. The back support member 46 can be locked in a raised position behind the seat by a suitable lock or interlock (not shown).

A body/torso support member 48 is attached to the second frame portion 18 above a distal end of the first flange 34 of the L-shaped member 32. The body support member 48 includes a support rod 50 extending upwards from the walker 10, and two support projections 52 for positioning as a loop substantially surrounding the user's torso or waist. Each support projection 52 is attached to an end of the support rod 50. Each support projection 52 extends towards a side and rear end of the frame 12 in a curved manner, together forming the body support member 48 that provides support around the torso or waist of the person using the walker 10.

The body support member 48 is disposed above the seat 18 where a pivotal axis for swivelling of the seat 18 passes through a central space or region defined by the body support member 48. This provides another type of support to prevent the person using the walker 10 from falling off from the walker 10.

The first and second guide members 54, 56 are slidably connected to the first and second arms 38, 40 of the second frame portion 16. A first end of each guide member 54, 56 of the second frame portion 16 is pivotally mounted substantially centrally of the elongate body 26 of each Y-shaped member 22 of the first frame portion 14. Each guide member 54, 56 extends from its first end to a second end in a direction towards the L-shaped member 32 of the second frame portion 16 and the seat 18.

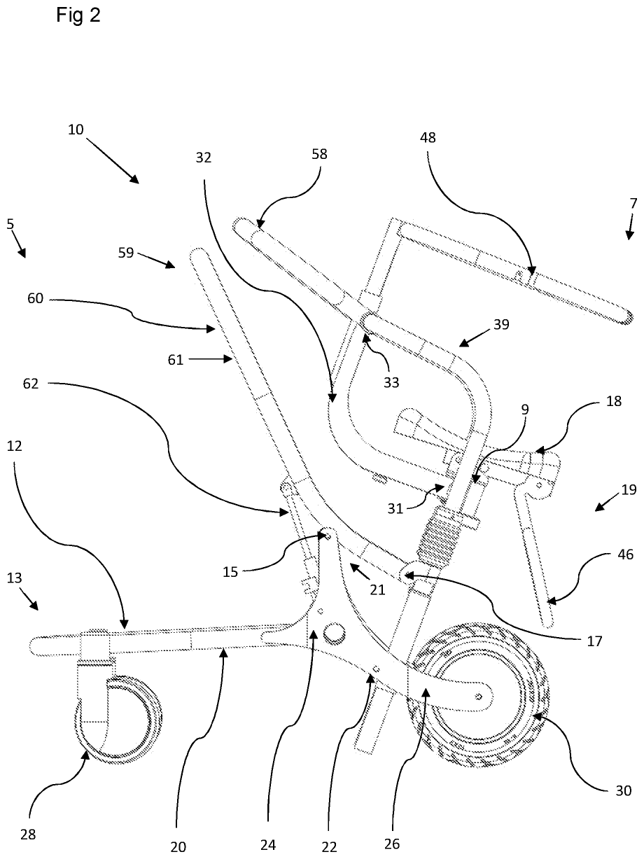

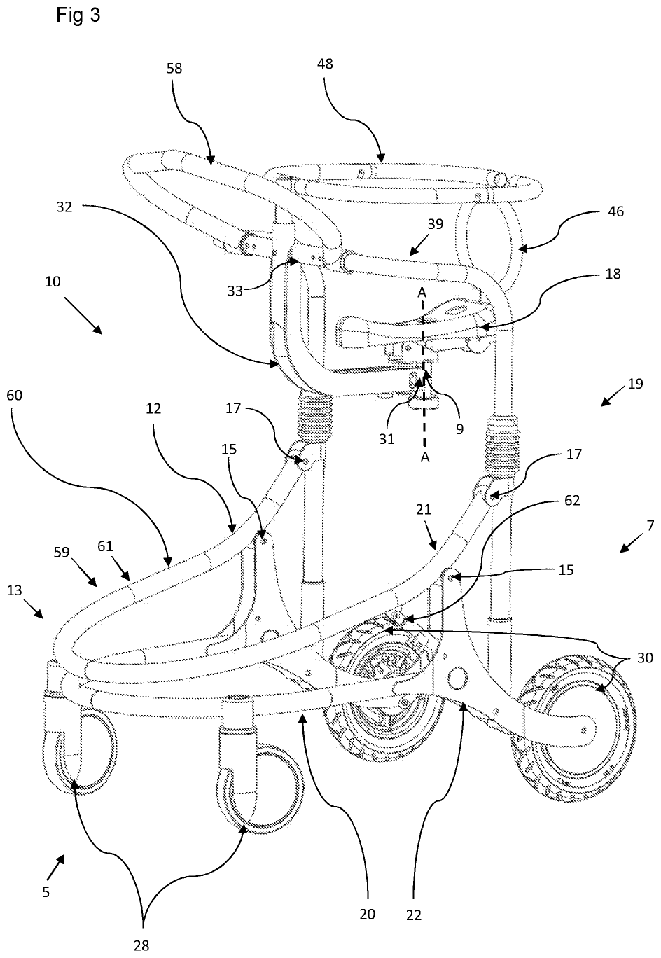

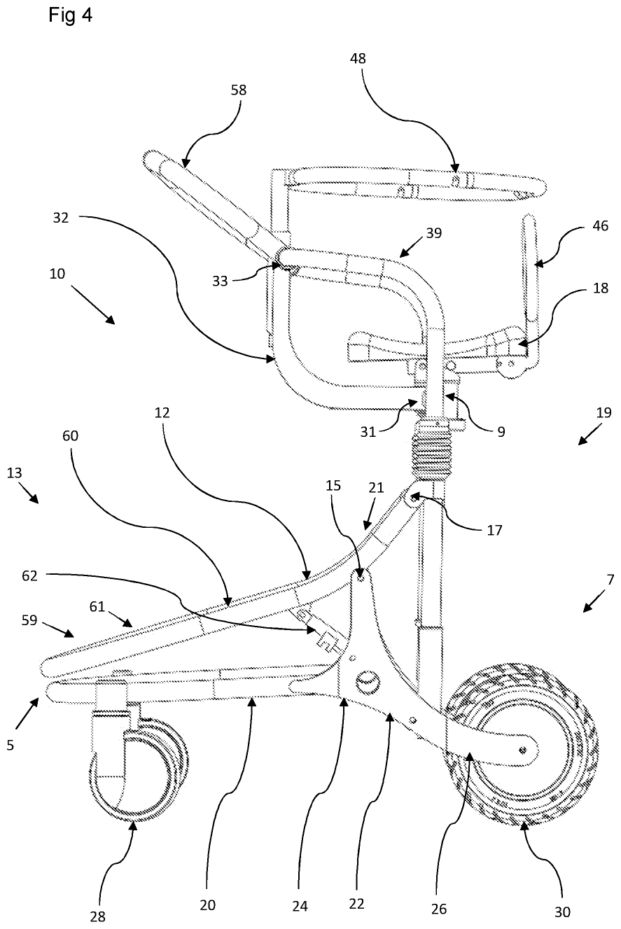

The first and second arms 38, 40 are slidable through the first and second guide member 54, 56, respectively. The sliding movement of the arms 38, 40 through the guide members 54, 56 allows the second frame member 16 and the seat 18 to be configured in a lowered position as shown in FIGS. 1 and 2 and in the raised position as shown in FIGS. 3 and 4.

A grip member or grip bar 58 is connected to the second frame portion 16, in this embodiment to the arms 38, 40. The grip member 58 is in the shape of a loop, but other forms of grip member may be provided in other embodiments.

The seat positioning means 60 is pivotally mounted to each arm 38, 40 of the second frame portion 16 about a first lateral axis. The first axis extends in a direction between the parallel first arm 38 and second arm 40 of the second frame portion 16 extending towards the first frame portion 14.

The seat positioning means 60 is disposed mainly in the front half of the walker 10, and operable from the front of the frame 12. The seat positioning means 60 may be considered as another portion of the frame 12. The seat positioning means 60 has a member 61 having U-shaped profile or a bar having two ends. Each end of the seat positioning means 60 is pivotally connected to a central portion of the parallel arms 38, 40 of the second frame portion 16 extending towards the first frame portion 14.

The U-shaped seat positioning means 60 is substantially similar to the U-shaped part of the first frame portion, such that it can substantially overlie the U-shaped member 20 when in the configuration in FIGS. 3-4. The seat positioning means 60 is a handle or a lever 60. The seat positioning means 60 can be manually operated (that is, pulled down or up by hand) to actuate the movement of the second frame portion 16 and the seat 18 between the lowered and raised positions.

A lower side of the seat positioning means 60 is pivotally mounted to a second end of the V-shaped part 24 of each Y-shaped member 22 about a second lateral axis. The second axis extends in a direction substantially parallel to the first axis. The pivotal connection of the seat positioning means 60 with the Y-shaped member 22 is disposed between the front end of the frame 12 and the second pivotal connection (where the arms 38, 40 of the second frame portion 16 are pivotally connected with the seat positioning means 60).

In other words, the pivotal connection of the seat positioning means 60 and the Y-shaped members 22 is disposed between the rear wheel 30 and the connection of the Y-shaped member 22 to the U-shaped member 20 of the first frame portion 14.

A lift or assistance means 62 such as a piston is disposed on one side of the frame 12 (although lift means may be provided on both sides in other embodiments).

A first end of the lift means 62 is connected to the first frame portion 12, in this embodiment to part of the U-shaped member 20 which sits in the Y-shaped member 22. The piston 62 connection to the first frame portion 12 is situated substantially vertically below the pivotal connection between the handle 60 and the first frame portion 12.

A second end of the lift means 62 is pivotally connected to a side (preferably an underside) of the U-shaped seat positioning means 60 between the front end of the frame 12 and the pivotal connection of the Y-shaped member 22 with the seat positioning means 60. The piston 62 connection to the handle 60 is relatively close to the pivotal connection between the handle 60 and the first frame portion 12.

A shock absorber 42 is provided on each arm 38, 40 of the second frame portion 16. The shock absorber 42 is disposed substantially centrally of the arm 38, 40 above the pivotal connection of the arm 38, 40 with the seat positioning means 60. A cover is provided around each shock absorber 42 to protect the shock absorber.

The seat positioning means 60 can be manually actuated by moving it downwards to move the second frame portion 16 and the seat 18 from a lowered position as shown in FIGS. 1 and 2 into the raised position as shown in FIGS. 3 and 4 (and vice versa by moving the handle/lever 60 upwards).

To commence use of the walker, with a user sat on or positioned over the lowered seat, pivoting the seat positioning means 60 about the first axis moves the seat 18 and the second frame member 16 upwards and forwards at the same time (or downwards and rearwards for lowering the seat 18). Starting from the FIG. 1 arrangement, this moves the second frame portion 16 and the seat 18 into the raised position as shown in FIGS. 3 and 4.

Pivoting the seat positioning means 60 towards the front end of the frame 12 causes the arms 38, 40 of the second frame portion 16 to move upwards towards the second end of the guide members 54, 56, which can also hide the ends of the arms 38, 40 so that they are not in the way during walking in the walker 10. This moves the second frame portion 16 and the seat 18 into the raised position as shown in FIGS. 3 and 4.

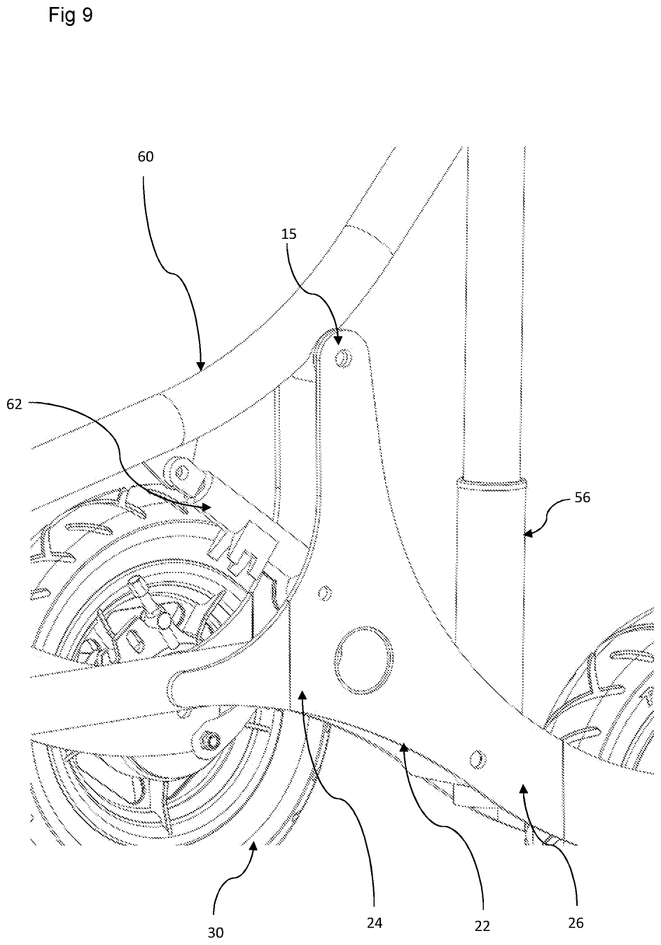

As the lever 60 is pushed/pulled down towards the first frame portion 12, the lift means 62 retracts or is forced to compress/shorten (see FIG. 9) as the distance between the first frame portion 14 and the seat positioning means 60 reduces. This primes the lift means 62 for subsequent controlled raising of the seat 18. The seat positioning means 60 thus raises the second frame portion 16 and the seat 18 into the raised position, which corresponds to a walking position. The walking position is the position the walker 10 is kept in while the person walks using the walker 10.

Following use of the walker, with a user standing over or supported by the raised seat, pivoting the seat positioning means 60 towards the rear end of the frame 12 causes the arms 38, 40 of the second frame portion 16 to move downwards towards the first end of the guide members 54, 56. Starting from the FIG. 3 arrangement, this moves the second frame portion 16 and the seat 18 in the lowered position as shown in FIGS. 1 and 2.

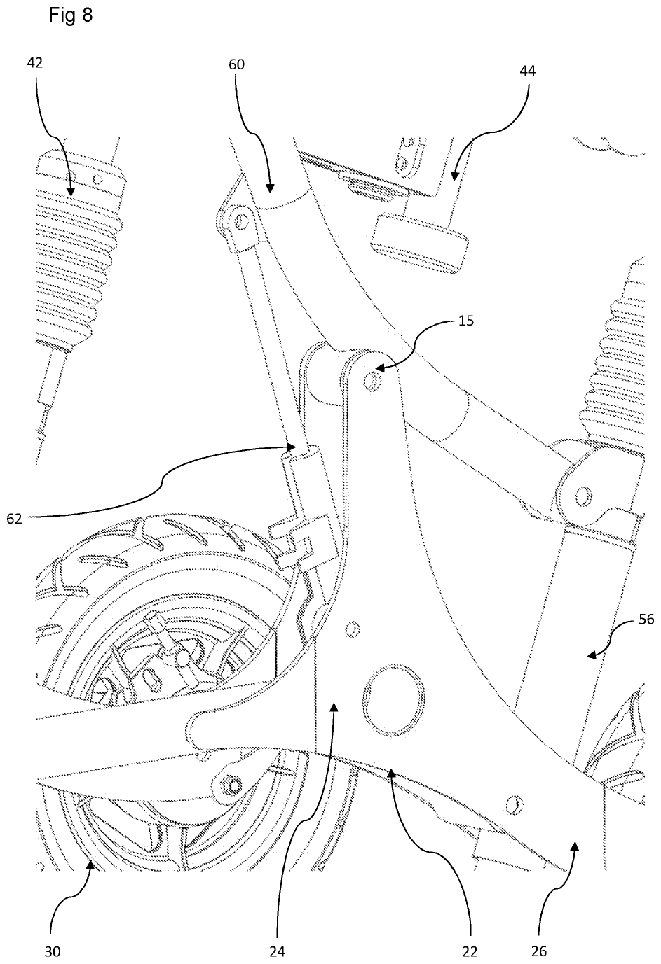

As the seat positioning means 60 is pivoted towards the rear end of the frame 12, the lift means 62 such as a piston extends (see FIG. 8) and helps to control the speed with which the handle rises and the seat lowers. This avoids dropping the seat away from the person in the walker 10 too quickly, so that they are able to safely transfer their weight more fully onto their legs (having previously been partially supported by the seat 18). The lift means 62 also restricts the seat positioning means 60 from lowering the second frame portion 16 and the seat 18 further than desired, e.g. because the piston has a maximum working extension. Once the seat has been lowered, this allows the person using the walker 10 can easily exit from the rear of the walker 10, and the walker is ready for use next time.

The seat 18 in the described embodiment is a saddle, although other forms of seat are contemplated within the scope of the disclosure. The seat 18 can swivel about a substantially vertical axis A-A during use. This helps the person using the walker to walk with a more natural gait, as the seat 18 pivots left and right in a reciprocating manner as the person walks.

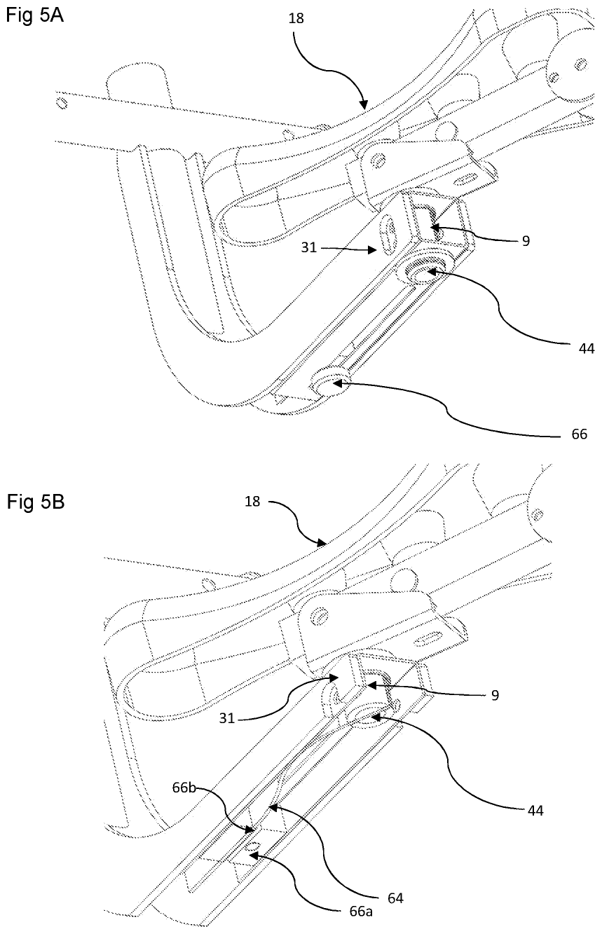

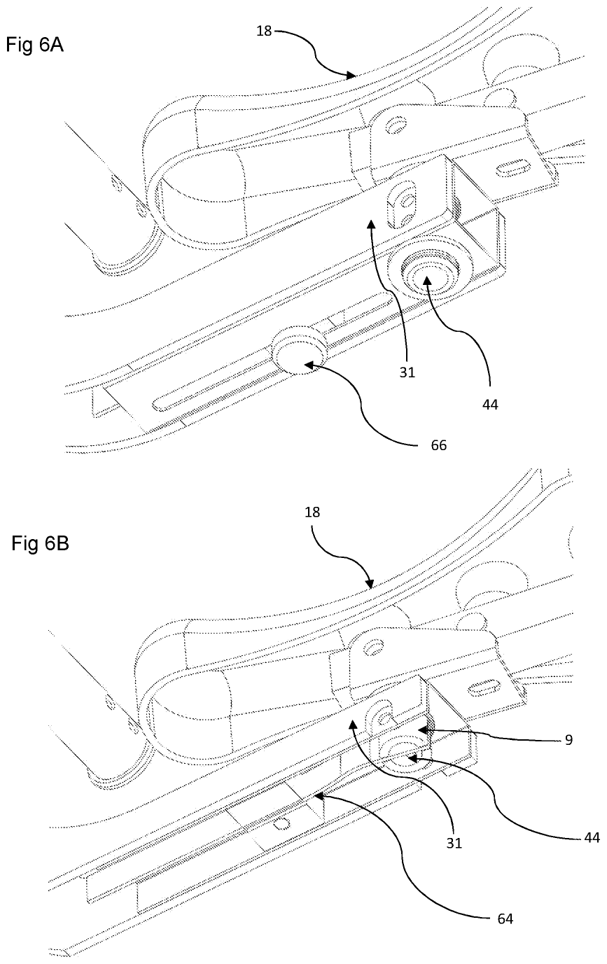

To avoid the seat swivelling in a way which might destabilise the user, the seat includes a resistance means 64, such as a leaf spring, for resisting the rotation of the seat 18 about the pivot during use. The resistance means 64 is shown in FIGS. 5B and 6B.

The resistance means may be considered to be an elongate deformable member connected between the seat and frame.

The resistance means (or tension adjuster) 64 is disposed along and/or within the lateral portion 36 of the L-shaped member 32 of the second frame portion 16.

A first end of the resistance means 64 is disposed at the distal end of the second flange 36. The resistance means 64 is attached to the seat rod 44 by extending through the centre of the seat rod 44 substantially perpendicularly to the length of the seat rod 44, i.e. to the pivot axis. A second end of the resistance means is disposed at the proximal end of the second flange 36.

It will be appreciated that it the resistance means has a length of cable 64 or other member 64, then using a mechanism like that discussed with respect to FIGS. 5A to 7B allows a degree of control over the angular range through which the seat may swivel clockwise/anticlockwise during use. For an inextensible cable, adjusting the length of slack in the cable can affect the resistance to seat swivelling. For an extensible cable, the stretchiness or extensibility of the cable (or material thereof) can affect the resistance to seat swivelling. Ideally, the range is limited to less ±45 degrees, and may be in the region of ±30 degrees, from a default forward-facing orientation of the seat 18.

A control means 66 is provided under the second flange 36 of the L-shaped member 32. The control 66 is connected to the resistance means 64 for adjusting the resistance force provided by the resistance means 64 to rotation of the seat 18. The control means 66 includes a knob that can be moved towards or away from the pivot axis to adjust the resistance of the resistance means 64.

The control means includes a block 66a, which has a groove or receiving portion 66b for the resistance means 64. A similar groove/receiving portion is provided in the seat rod 44. The block 66a is sized to fit in and slide along the underside of the L-shaped member 32.

Internal left/right side walls of the L-shaped member limit lateral deformation of the resistance means when the seat is swivelled.

A plate including a longitudinal slot (see e.g. FIG. 6A) is provided under the resistance means 64. The control means is configured to move between the closed ends of the slot, or to any intermediate position along the slot.

The control means 66 (or block) contacts the resistance means 64 on either side and is slidable linearly along the resistance means 64. The further the control means 66 is positioned from the first end of the resistance means 64 (i.e. further from the seat pivot axis), the less resistance is applied to the rotation of the seat 18. On the other hand, the further the control means 66 is positioned from the second end of the resistance means 64 (i.e. closer to the seat pivot axis), the more resistance is applied to the rotation of the seat 18.

In FIGS. 5A and 5B, the control means 66 is in a first position (the slotted plate is not shown in FIG. 5B). The control means 66 is disposed at the far end of the resistance means 64, furthest from the seat pivot axis, and at the proximal end of the second flange 36 of the L-shaped member 32 of the second frame portion 16. From FIG. 5B, the resistance means 64 is shown to be curved or deformed between the control means 66 and the seat rod 44. The resistance means 64 is less constrained against deformation by the control means 66, so the seat 18 is subjected to a lower force against swivelling from the resistance means 64.

In FIGS. 6A and 6B, the control means 66 is in a second position (the slotted plate is not shown in FIG. 6B). The control means 66 is disposed partway along the length of the resistance means 64 (and slot). That is, partway along the length of the second flange 36 of the L-shaped member 32. From FIG. 6B, the resistance means 64 is more constrained against deformation by the control means 66, relative to FIG. 5A, meaning that a greater force must be applied to achieve the same degree of swivel as in FIG. 5A. That is, rotation of the seat 18 is more limited compared to the first position.

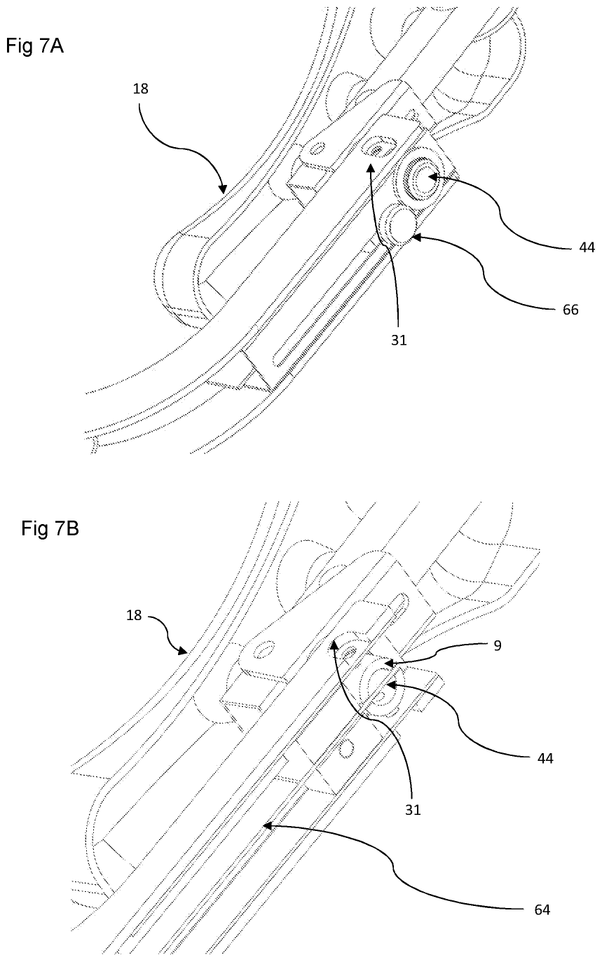

In FIGS. 7A and 7B, the control means 66 is in a third position (the slotted plate is not shown in FIG. 7B). The control means 66 is disposed at the near end of the resistance means 64, closest to the seat pivot axis, and next the seat rod 44 at the distal end of the L-shaped member 32. From FIG. 7B, the resistance means 64 is constrained by the control means 66 such that it is substantially planar. This restricts the resistance means 64 further compared to the second position. In this position, the resistance means 64 has restricted the rotation of the seat 18 to the maximum resistance allowed by the resistance means 64. That is, the seat cannot swivel very much at all. This may be preferred when a user is first learning to use the walker.

In some embodiments, the seat 18 is tiltable towards the front end of the frame 12 and/or towards the rear end of the frame 12. The tilt angle can be set prior to use. A tilt adjustment means (not shown) is connected to the seat 18 for setting the tilt angle of the seat 18.

The embodiments described above are provided by way of example only, and various changes and modifications will be apparent to persons skilled in the art without departing from the scope of the present invention as defined by the appended claims.

What is claimed is:

1. A walker for assisting a person to walk independently, the walker comprising:
a frame including a first frame portion and a second frame portion, the second frame portion being disposed above the first frame portion and the second frame portion being movable relative to the first frame portion via at least one pivotal connection;
one or more wheels connected to the first frame portion for rolling the walker along the ground;
a seat connected to the second frame portion and disposed above the first frame portion, the seat and the second frame portion being configurable into a lowered position for a person to enter or exit the walker, and into a raised position for the person to walk using the walker in which the seat is disposed above a horizontal plane at the at least one pivotal connection;
a front end of the frame is disposed ahead of the at least one pivotal connection and the seat is disposed rearwardly of the at least one pivotal connection; and
seat positioning means configured or arranged for use in moving the second frame portion relative to the first frame portion for moving the seat between the lowered and raised positions; in which
in the raised position, the seat is disposed above a horizontal plane at the at least one pivotal connection.

2. A walker as claimed in claim 1, in which first frame portion extends from a front end to a rear end of the walker, and the at least one pivotal connection is disposed in a middle region of the first frame portion between the front end and rear end of the walker.

3. A walker as claimed in claim 1, in which the seat positioning means includes a third frame portion which is pivotally connected to the first frame portion at a first pivotal connection and pivotally connected to the second frame portion at a second pivotal connection, the seat being disposed rearwardly of the first pivotal connection.

4. A walker as claimed in claim 1, in which the seat positioning means includes a handle or lever which is one or both of: disposed at a front end of the walker, and operable from the front end of the walker.

5. A walker as claimed in claim 1, in which the seat positioning means is configured or arranged to perform one or both of:
move the seat both upwards and forwards from the lowered position; and
move the seat both downwards and rearwards from the raised position.

6. A walker as claimed in claim 1, in which, in the lowered position, the seat is disposed above the horizontal plane at the at least one pivotal connection.

7. A walker as claimed in claim 1, in which the seat is oriented at a first tilt angle in the raised position, and the seat is oriented at a different second tilt angle in the lowered position.

8. A walker as claimed in claim 1, in which lift means is connected to the seat positioning means for assisting controlled movement of the second frame portion and the seat from the raised position to the lowered position.

9. A walker as claimed in claim 8, in which the lift means includes a piston or gas strut connected between the seat positioning means and the first frame portion.

10. A walker as claimed in claim 1, in which the first frame portion includes one or both of:
a U-shaped member or portion arranged laterally with its closed end at the front of the walker for providing space to step forward within the frame; and
two Y-shaped members or portions each disposed towards a rear end of the walker for housing rear wheels, and the at least one pivotal connection being provided at an upper end of each Y-shaped member.

11. A walker as claimed in claim 1, in which the seat positioning means includes a U-shaped member for substantially overlying the first frame portion when the seat and second frame portion are in the raised position.

12. A walker as claimed in claim 1, in which the second frame portion includes an L-shaped member or portion, and the seat is mounted to a first end of the L-shaped member or portion.

13. A walker as claimed in claim 12, in which the second frame portion includes a cross bar across a second end of the L-shaped member or portion, and first and second arms extend downwards from the cross bar on either side of the seat.

14. A walker as claimed in claim 1, in which the frame includes first and second guide members arranged to receive at least part of the second frame portion therethrough for guiding movement of the second frame portion when the seat and second frame portion are raised or lowered.

15. A walker as claimed in claim 14, in which the first and second guide members of the second frame portion are each pivotally mounted to the first frame portion.

16. A walker as claimed in claim 1, in which the seat is rotatably connected to the frame at a pivot for rotating in either direction about a substantially vertical axis, and resistance means in the walker is configured to provide a force for resisting rotation or swivel of the seat in either direction about the pivot, optionally in which control means is provided for adjusting the force provided by the resistance means.

17. A walker as claimed in claim 1, in which the frame includes a body support member for positioning around the person's torso or waist to support them against falling over, and the substantially vertical axis about which the seat pivots passes through a central region of a space defined by the body support member.

18. A walker as claimed in claim 1, in which the frame includes at least one of a front grip portion, a loop or a ring for the person to grip during use.

19. A walker as claimed in claim 1, in which a back support member is provided behind the seat and pivotally attached to the seat.
